(19) United States
(12) Patent Application Publication
(10) Pub. No.: US 2023/0060528 A1
(43) Pub. Date: Mar. 2, 2023

(54) RESERVOIR FLUID FLOW PROFILING IN A WELLBORE ENVIRONMENT

(71) Applicant: Saudi Arabian Oil Company, Dhahran (SA)

(72) Inventors: Noureddine Benlakhdar, Dhahran (SA); Mamdouh N. Al-Nasser, Dhahran (SA)

(21) Appl. No.: 17/458,935

(22) Filed: Aug. 27, 2021

(51) Int. Cl. G01V 3/38; E21B 47/07; E21B 47/10; G01V 1/50

(52) U.S. Cl. CPC G01V 3/38; E21B 47/07; E21B 47/10; G01V 1/50; E21B 2200/20; G01V 99/005

(57) ABSTRACT

A system and methods for electrolysis of saline solutions are provided. An exemplary method provides simulating temperature gradients of reservoir fluids at different well conditions in a well, wherein the reservoir fluids include oil and water. A total flow rate of the reservoir fluids is quantified based on the simulated temperature gradients, and a water flow rate of water in the reservoir fluids is calculated based on, at least in part, a pulsed neutron log. An oil flow rate is calculated from the total flow rate of the reservoir fluids and the water flow rate.

### TECHNICAL FIELD

The present disclosure describes profiling reservoir fluid flow in a wellbore environment and, more particularly, an oil flow rate determination in a harsh wellbore environment.

### BACKGROUND

Fluid flow is the movement of fluid through pores and fractures within permeable rocks in a reservoir. Fluid flow may be directly measured using mechanical spinners and holdup probes. During harsh wellbore conditions, mechanical parts of a downhole tool string used to measure fluid flow can be affected by the downhold fluid properties. Moreover, the presence of sticky material in the well can limit the use of mechanical spinners and holdup probes.

### SUMMARY

An embodiment described herein provides flow profiling. In an embodiment, temperature gradients of reservoir fluids are simulated at different well conditions in a well, wherein the reservoir fluids include oil and water. A total flow rate of the reservoir fluids is quantified based on the simulated temperature gradients. A water flow rate of water in the reservoir fluids is calculated based on, at least in part, a pulsed neutron log. An oil flow rate is calculated from the total flow rate of the reservoir fluids and the water flow rate.

### BRIEF DESCRIPTION OF DRAWINGS

FIG. 1 is a block diagram of a process for flow profiling according to the present techniques.

FIG. 2 is a block diagram of a process for flow profiling according to the present techniques.

FIG. 3 is a block diagram of a controller that can be used to determine fluid flow rates and generate a fluid flow profile according to the present techniques.

### DETAILED DESCRIPTION

Embodiments described herein enable reservoir fluid flow profiling in a wellbore environment. Organic compounds, including oil and water, occur naturally in a reservoir and exhibit multiphase behavior over a wide range of temperatures and pressures. The various phase behaviors along with the physical properties of the reservoir rock formation results in a wide range of wellbore environments. In some cases, the wellbore environment is harsh, with a sticky material that prevents an accurate determination of wellbore characteristics using mechanical downhole tools, such as array spinners and holdup measurements. For example, sticky material in a harsh wellbore environment includes, but is not limited to, debris, heavy oil, sand or solids with oil, and asphaltenes.

Traditional techniques use an array spinner and holdup measurements to represent the phase velocity and fluid fractions which have limitations in harsh downhole conditions. The present techniques provide velocity and holdup measurements based on temperature simulation, noise logs, and pulsed neutron logs, which are not affected by borehole conditions. Thus, the present techniques enable a determination of an oil flow rate without the use of mechanical spinners (e.g., a flowmeter with collapsible blades) or holdup probes (e.g., a tool used to determine a fraction of a particular fluid present in an interval of pipe). In embodiments, the present techniques use different physics for fluid velocity and holdup measurements (temperature, neutron, sounds) while traditional techniques use mechanical measurements which are heavily affected by the borehole conditions.

In embodiments, the present techniques use noise logging and numerical temperature simulation combined with a pulsed neutron log to provide an accurate oil/water production profile in harsh borehole environment. A profile can include flow behavior in horizontal wells modeled in the presence of sticky material. In examples, the present techniques provide an accurate production profile while gathering information regarding the reservoir performance across the horizontal lateral. Additionally, the present techniques enable flow profiling behind pipes, leak detection, and formation communication.

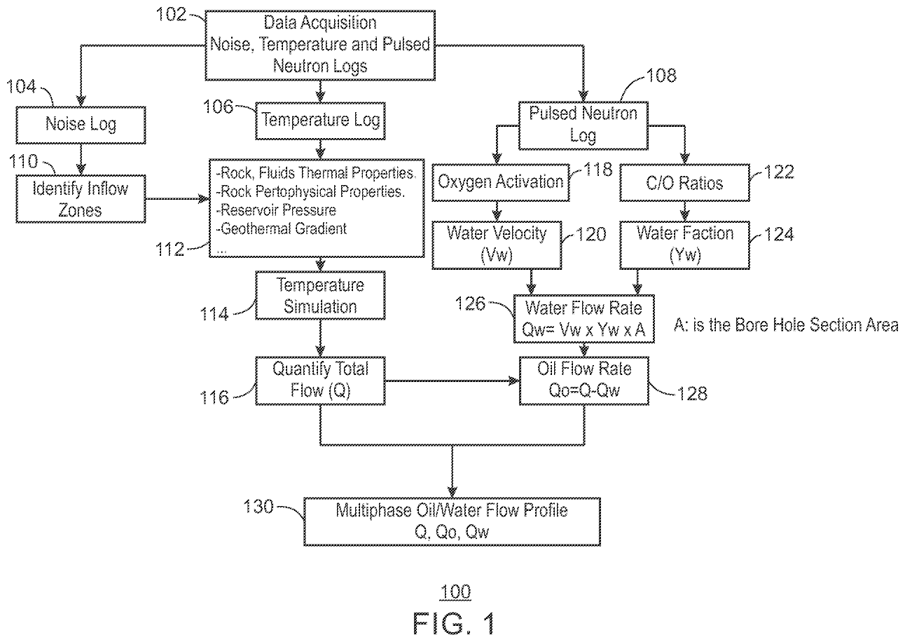

FIG. 1 is a block diagram of a process 100 for flow profiling according to the present techniques. In an example, the present techniques enable an indirect oil flow rate calculation using a noise log, temperature log, and pulsed neutron log. In this manner, flow profile data is calculated in a borehole with sticky material where flow profile data cannot be acquired with conventional production logging tools. In embodiments, noise logging and numerical temperature simulation is combined with a pulsed neutron log to provide an accurate oil/water production profile, identify formation fractures, and check for possible cross flows in a horizontal oil producer with high water cut and the presence of sticky materials.

Conventional techniques are limited to the use of an array spinner and holdup measurements to represent the phase velocity and fluid fractions which have limitations in harsh downhole conditions. The present techniques enable fluid flow profiling in the presence of harsh downhole conditions resulting from sticky materials and high water cut. The present techniques provide velocity and holdup measurements based on temperature simulation, noise and pulsed neutron logs which are not affected by borehole conditions.

As illustrated in FIG. 1, at block 102 data is acquired from one or more logs. In examples, a log is detailed record of the geologic formations, physical measurements, or any combinations thereof, penetrated by a borehole. FIG. 1 includes a noise log 104, a temperature log 106, and a pulse neutron log 108. Through the use of logs, the present techniques provide dynamic reservoir flow monitoring regardless downhole conditions which enables more efficient, informed reservoir management.

In an embodiment, a noise log 104 is generated by a noise-logging tool that passively listens to downhole noise. In examples, downhole noise can be generated from gas bubbling in the fluids in the reservoir. Noise can also be created by the flow of fluids through the channels within the wellbore. The noise-logging tool can capture noise associated with the fluid flow through the wellbore. In embodiments, a temperature-logging tool senses the temperature within the wellbore to generate a temperature log 106. For example, a temperature-logging tool passively records a temperature gradient in the well, with temperature logging executed in continuous mode. A temperature gradient of a well can be used to detect zones of the well that produce or take fluid. In examples, the temperature gradient can be used to determine physical properties of the rock. In an embodiment, a pulsed neutron log 108 is created by a pulsed neutron tool that measures a die-away time of a short-lived neutron pulse using induced gamma ray spectroscopy with a pulsed neutron generator. In examples, the pulsed neutron logging is executed in both stationary and continuous mode.

In embodiments, the noise log 104 is run in stations and is able to capture noise generated by fluid movement within the wellbore at a wide range of amplitudes (decibels) and frequencies within a wide scanning radius. In examples, stations are downhole measurements recorded versus time at a given depth (wireline is at stop condition). This enables an identification of inflow zones at block 110. In examples, inflow zones are active zones. Active zones have different depth (location) within the borehole and can be detected by noise log using noise frequencies and amplitude. In embodiments, the noise log enables a check for fracture signatures. In an example, a fracture signature is an indicator in the noise log data that corresponds to or is associated with a fracture. When fracture is active, then it is part of the inflow zone and is detected by noise log. In an example, a noise log for active zone identification is processed to remove coherence noise. Additional noise can be removed, where the additional noise covers effective (natural) noise. In embodiments, negligible flow zones are identified. In embodiments, after noise removal active fractures are identified in the noise log.

Referring again to FIG. 1, the identified inflow zones at block 110 are input to block 112. At block 112, the temperature log and the identified inflow zones are received. A number of properties are extracted from the temperature log data for the identified inflow zones. In examples, for the identified inflow zones the following data is extracted: rock and fluid thermal properties; rock petrophysical properties; reservoir pressure; and geothermal gradient. At block 114, the extracted data is input to a temperature simulation. In embodiments, an advanced numerical temperature simulator is used to execute a temperature simulation. A total flow (Q) is quantified according to the temperature simulation at block 116. As described below, the total flow Q is used to determine an oil flow rate at block 128. In embodiments, a total flow Q is the total flow of oil and water in the well. The total oil flow Q correlates with changes in temperature gradients and the active zones provided by the noise log across the horizontal section.

In an embodiment, the temperature simulator executes according to a temperature mixture model. The temperature mixture model characterizes mixture temperatures Tₘᵢₓ, inflow temperatures T_{inflow}, upwards temperatures T_{upward}, static temperatures, flowing temperatures, and geothermal temperatures for one or more zones of a wellbore. The temperature mixture model is operable according to the following energy conservation law:

(QρcT)ᵤₚ+(QρcT)ᵢₙ=((Qρc)ᵤₚ+(Qρc)ᵢₙ)Tₘᵢₓ

wherein up is an upward flow, in indicates an inflow from a current layer, c is the heat capacity of fluid, Q is a flow rate, and p is the fluid density. In an embodiment, Tₘᵢₓ is defined as follows:

$${T}_{mix} = \frac{{( Q ρ c T )}_{up} + {( Q ρ c T )}_{in}}{{( Q ρ c )}_{up} + {( Q ρ c )}_{in}}$$

In embodiments, the amplitude of stepwise change in the temperature mixture model depends on initial temperatures, heat capacities, and rates of both flows. In embodiments, the temperature mixture model is iteratively updated based on new or updated temperature log data.

Referring again to FIG. 1, the oil flow rate is found by the total flow Q and data from the pulsed neutron log at block 108. At block 118, oxygen activation is applied to data from the pulsed neutron log. In an embodiment, oxygen can be activated by high energy neutrons to produce an isotope of nitrogen, which decays back to oxygen and emits gamma rays that can be detected. This oxygen activation detects and quantifies the flow of water in or around a borehole. At block 120, a water velocity V_{w} is determined from the oxygen activation.

At block 122, carbon/oxygen (C/O) ratios are determined from the pulsed neutron log 108. The C/O ratios enable an evaluation of differences in water and oil saturations independent of formation water salinity. In an embodiment, the C/O ratio is obtained from a C/O tool. At block 120, a water faction Y_{w} is determined from the C/O ratios.

In an embodiment, the C/O model for water faction calculation is as follows:

$$\begin{matrix}NCOR = \frac{{N}_{1} ( 1 - ∅ ) + {N}_{2} ∅ {S}_{0} + {N}_{3} {Y}_{0}}{{N}_{4} ( 1 - ∅ ) + {N}_{5} ∅ {S}_{w} + {N}_{6} {Y}_{w}} \\ FCOR = \frac{{F}_{1} ( 1 - ∅ ) + {F}_{2} ∅ {S}_{0} + {F}_{3} {Y}_{0}}{{F}_{4} ( 1 - ∅ ) + {F}_{5} ∅ {S}_{w} + {F}_{6} {Y}_{w}} \\ {S}_{w} + {S}_{0} = 1 \\ {Y}_{w} + {Y}_{0} = 1\end{matrix}$$

In an example, the pulsed neutron log provides a water velocity measurement V_{w} using an oxygen activation technique, and with C/O ratios the water fraction Y_{w} in the borehole can be measured. Hence, a water flow can be profiled.

Referring again to FIG. 1, at block 126, a water flow rate Q_{w} is calculated using the water velocity V_{w}, water faction Y_{w}, and the borehole section area (A) as follows:

Q_{w}=V_{w}*Y_{w}*A

At block 128, the oil flow rate Qₒ is indirectly calculated by subtracting the water flow rate Q_{w} from the total flow (Q) output by the temperature simulation as follows:

Qₒ=Q−Q_{w}

Indirectly calculating an oil flow rate refers to calculating the oil flow rate without direct measurement of oil properties in the well. At block 130, a multiphase oil and water profile is generated using the total flow Q, the oil flow rate Qₒ, and the water flow rate Q_{w}. In examples, a multiphase flow characterizes the simultaneous flow of both liquid (oil or condensate and water) and vapor (gas). In embodiments, the present techniques combine a total flow rate calculated from noise and temperature logs with a water flow rate calculated from a pulsed neutron log to build a full multiphase oil/water flow profile.

In an embodiment, the indirect oil flow rate and water flow rate determination as described in the example of FIG. 1 is verified by executing noise and temperature logging, combined with a pulsed neutron log generated from data collected by a pulsed neutron tool under various well conditions. Note that the tool string contains no mechanical parts that might be affected by the downhole fluid properties. In an embodiment, the various well conditions include flowing, transient, and shut in conditions. In embodiments, the data captured during said logging is compared with direct oil flow rate and water flow rate measurements for further use in mathematical models.

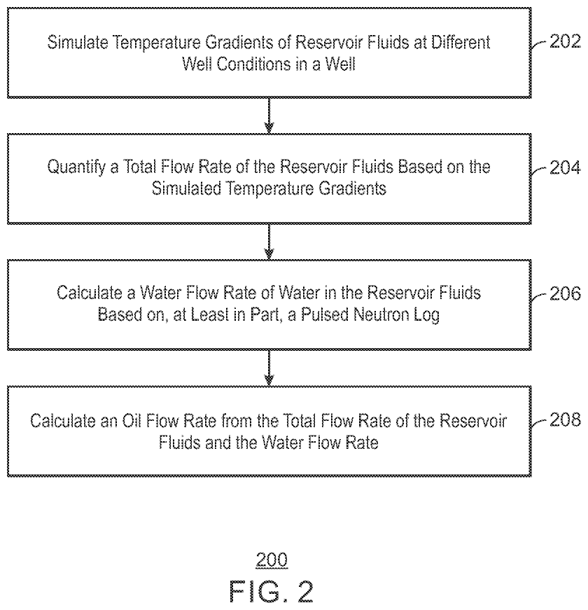

FIG. 2 is a process flow diagram of a process 200 for fluid flow profiling.

At block 202, temperature gradients in a wellbore environment are simulated. In embodiments, a temperature simulation is executed at different well conditions. The well conditions may be, for example, static, transient, and flowing. The well conditions may be based on, at least in part inflow zones identified from a noise log of the wellbore environment. In an example, a static well is a well that has been closed for a period of time. A transient well is a well that is flowing at variable rates. A flowing well is a well that is flowing at a constant rate.

At block 204, a total flow rate of the reservoir fluids is quantified based on the simulated temperature gradients. In an embodiment, the temperature simulator executes according to a temperature mixture model. At block 206, a water flow rate of water in the reservoir fluids is calculated based on, at least in part, a pulsed neutron log. In an embodiment, an oxygen activation technique and C/O ratios are used to determine the water flow rate. The oxygen activation technique and C/O ratios may be calculated using the pulse neutron log. At block 208, an oil flow rate is calculated from the total flow rate of the reservoir fluids and the water flow rate. In an embodiment, a multiphase oil and water profile is generated using the total flow, the oil flow rate, and the water flow rate.

The process flow diagram of FIG. 2 is not intended to indicate that the blocks of the example process 200 are to be executed in any order, or that all of the blocks are to be included in every case. Further, any number of additional blocks not shown may be included within the example process 200, depending on the details of the specific implementation.

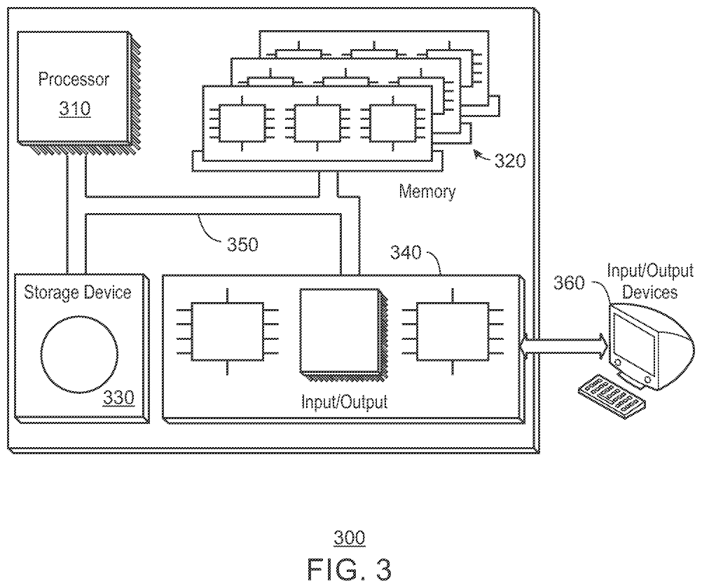

FIG. 3 is a schematic illustration of an example controller 300 (or control system) for determining fluid flow rates and generating a fluid flow profile according to the present disclosure. For example, the controller 300 may include or be part of the process 100 shown in FIG. 1 or operable according to the process 200 of FIG. 2. The controller 300 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 300 includes a processor 310, a memory 320, a storage device 330, and an input/output interface 340 (for displays, input devices, example, sensors, valves, pumps). Each of the components 310, 320, 330, and 340 are interconnected using a system bus 350. The processor 310 is capable of processing instructions for execution within the controller 300. The processor may be designed using any of a number of architectures. For example, the processor 310 may be a CISC (Complex Instruction Set Computers) processor, a RISC (Reduced Instruction Set Computer) processor, or a MISC (Minimal Instruction Set Computer) processor.

In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output devices 360.

The memory 320 stores information within the controller 300. In one implementation, the memory 320 is a computer-readable medium. In one implementation, the memory 320 is a volatile memory unit. In another implementation, the memory 320 is a nonvolatile memory unit.

The storage device 330 is capable of providing mass storage for the controller 300. In one implementation, the storage device 330 is a computer-readable medium. In various different implementations, the storage device 330 may be a floppy disk device, a hard disk device, an optical disk device, or a tape device.

The input/output interface 340 provides input/output operations for the controller 300. In one implementation, the input/output devices 360 includes a keyboard and/or pointing device. In another implementation, the input/output devices 360 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

Other implementations are also within the scope of the following claims.

What is claimed is:

1. A computer-implemented method for flow profiling, the method comprising:
simulating, with one or more hardware processors, temperature gradients of reservoir fluids at different well conditions in a well, wherein the reservoir fluids include oil and water;
quantifying, with one or more hardware processors, a total flow rate of the reservoir fluids based on the simulated temperature gradients;
calculating, with one or more hardware processors, a water flow rate of water in the reservoir fluids based on, at least in part, a pulsed neutron log; and
calculating, with one or more hardware processors, an oil flow rate from the total flow rate of the reservoir fluids and the water flow rate.

2. The computer implemented method of claim 1, comprising:
identifying inflow zones across a horizontal section of the well; and
extracting thermal properties from a temperature log of the well corresponding to inflow zones identified by a noise log of the well.

3. The computer implemented method of claim 1, wherein the different well conditions include static, transient, and flowing.

4. The computer implemented method of claim 1, comprising:
executing an oxygen activation technique to determine a water velocity of the reservoir fluids, wherein data is extracted from the pulsed neutron log and used to calculate the water flow rate.

5. The computer implemented method of claim 1, comprising:
determining a water faction of the reservoir fluids, wherein the water faction is calculated from C/O ratios extracted from the pulsed neutron log and used to calculate the water flow rate.

6. The computer implemented method of claim 1, wherein the water flow rate is based on, at least in part, a water velocity, a water faction, and a bore hole section area of the well.

7. The computer implemented method of claim 1, wherein the oil flow rate and the water flow rate are used to build a multiphase oil and water profile for the well.

8. The computer implemented method of claim 1, wherein the oil flow rate and water flow rate are used to identify formation fractures.

9. The computer implemented method of claim 1, wherein the oil flow rate and water flow rate are used to determine cross flows of reservoir fluids in the well.

10. A system, comprising:
one or more memory modules;
one or more hardware processors communicably coupled to the one or more memory modules, the one or more hardware processors configured to execute instructions stored on the one or more memory models to perform operations comprising:
simulating temperature gradients of reservoir fluids at different well conditions in a well, wherein the reservoir fluids include oil and water;
quantifying a total flow rate of the reservoir fluids based on the simulated temperature gradients;
calculating a water flow rate of water in the reservoir fluids based on, at least in part, a pulsed neutron log; and
calculating an oil flow rate from the total flow rate of the reservoir fluids and the water flow rate.

11. The system of claim 10, comprising:
identifying inflow zones across a horizontal section of the well; and
extracting thermal properties from a temperature log of the well corresponding to inflow zones identified by a noise log of the well.

12. The system of claim 10, wherein the different well conditions include static, transient, and flowing.

13. The system of claim 10, comprising:
executing an oxygen activation technique to determine a water velocity of the reservoir fluids, wherein data is extracted from the pulsed neutron log and used to calculate the water flow rate.

14. The system of claim 10, comprising:
determining a water faction of the reservoir fluids, wherein the water faction is calculated from C/O ratios extracted from the pulsed neutron log and used to calculate the water flow rate.

15. The system of claim 10, wherein the water flow rate is based on, at least in part, a water velocity, a water faction, and a bore hole section area of the well.

16. The system of claim 10, wherein the oil flow rate and the water flow rate are used to build a multiphase oil and water profile for the well.

17. An apparatus comprising a non-transitory, computer readable, storage medium that stores instructions that, when executed by at least one processor, cause the at least one processor to perform operations comprising:
simulating temperature gradients of reservoir fluids at different well conditions in a well, wherein the reservoir fluids include oil and water;
quantifying a total flow rate of the reservoir fluids based on the simulated temperature gradients;
calculating a water flow rate of water in the reservoir fluids based on, at least in part, a pulsed neutron log; and
calculating an oil flow rate from the total flow rate of the reservoir fluids and the water flow rate.

18. The apparatus of claim 17, comprising:
identifying inflow zones across a horizontal section of the well; and
extracting thermal properties from a temperature log of the well corresponding to inflow zones identified by a noise log of the well.

19. The apparatus of claim 17, wherein the different well conditions include static, transient, and flowing.

20. The apparatus of claim 17, comprising:
executing an oxygen activation technique to determine a water velocity of the reservoir fluids, wherein data is extracted from the pulsed neutron log and used to calculate the water flow rate.
